(19) United States
(12) Patent Application Publication
(10) Pub. No.: US 2002/0093606 A1
(43) Pub. Date: Jul. 18, 2002

(54) Display filter

(75) Inventor: Minoru Higuchi, Tokyo (JP)

Correspondence Address: Norman P. Soloway, HAYES, SOLOWAY, HENNESSEY, GROSSMAN & HAGE, P.C., 175 Canal Street, Manchester, NH, 03101, US

(73) Assignee: NEC Corporation

(21) Appl. No.: 10/050,770

(22) Filed: Jan. 16, 2002

(30) Foreign Application Priority Data
Jan. 16, 2001 (JP) 2001-8300

(51) Int. Cl. G02F 1/1335

(52) U.S. Cl. 349/104

(57) ABSTRACT

A display filter, which is arranged in alignment with a screen of a display unit, has a function of absorbing visible rays having a wavelength other than wavelengths of red, green and blue lights. For instance, the function is accomplished by a transparent substrate positioned in alignment with the screen, and a light absorber mixed in the transparent substrate, the light absorber absorbing visible rays having a wavelength other than wavelengths of red, green and blue lights.

### BACKGROUND OF THE INVENTION

1. Field of the Invention

The invention relates to a display filter used for a display unit such as a plasma display unit.

2. Description of the Related Art

FIG. 1 is a cross-sectional view of a conventional display filter.

A display filter 2 is arranged in alignment with a screen of a display unit 1, and has a function of equally reducing transmissivity in overall visible rays. That is, the display filter 2 reduces external lights directed to the display unit 1, and further reduces external lights reflected at the display unit 1.

For instance, assuming that the display filter 2 has a transmissivity of 70%, external lights having reached the display unit 1 are reflected at the display unit 1 by 49% (0.7×0.7=0.49). This means that an external light having been reached the display unit 1 through the display filter 2 is reflected again through the display filter 2 at 49% in comparison with an external light having been reached the display unit 1 without passing through the display filter 2. Thus, an external light is reflected at the display unit 1 to a less degree, ensuring enhancement of contrast of the display unit 1.

However, the conventional display filter 2 reduces transmissivity uniformly of overall visible rays. As a result, lights emitted from the display unit 1 such as red, green and blue lights are also reduced, resulting in reduction in a brightness of the display unit 1.

This causes a problem that an external light having been reflected at the display unit 1 is higher in a brightness than a light emitted from the display unit 1 in a bright place which is defined as a place in an external light, resulting in that contrast of the display unit 1 is reduced, and hence, a viewer cannot see clear images on a screen of the display unit 1.

### SUMMARY OF THE INVENTION

In view of the above-mentioned problem in the conventional display filter, it is an object of the present invention to provide a display filter which is capable of reducing only external lights and enhancing contrast in a bright place.

In one aspect of the present invention, there is provided a display filter arranged in alignment with a screen of a display unit, the display filter having a function of absorbing visible rays having a wavelength other than wavelengths of red, green and blue lights.

In the display filter in accordance with the present invention, visible rays having a wavelength other than wavelengths of red, green and blue lights are absorbed into the display filter. As a result, red, green and blue lights can pass through the display filter. Accordingly, lights emitted from the display unit such as red, green and blue lights are not reduced, but only external lights directing to the display unit and reflecting from the display unit are reduced.

There is further provided a display filter arranged in alignment with a screen of a display unit, the display filter having a function of absorbing only external light in an area where the display unit is used.

In the display filter in accordance with the present invention, only external light in an area where the display unit is located is absorbed into the display filter. Accordingly, lights emitted from the display unit such as red, green and blue lights are not reduced, but only external lights directing to the display unit and reflecting from the display unit are reduced.

In another aspect of the present invention, there is provided a liquid crystal display device including (a) a liquid crystal display unit emitting lights externally, and (b) a display filter arranged in alignment with a screen of the liquid crystal display unit, the display filter having a function of absorbing visible rays having a wavelength other than wavelengths of red, green and blue lights.

For instance, the function is accomplished by (a) a transparent substrate positioned in alignment with the screen, and (b) a light absorber mixed in the transparent substrate, the light absorber absorbing visible rays having a wavelength other than wavelengths of red, green and blue lights.

For instance, the function is accomplished by (a) a transparent film, (b) a light absorber mixed in the transparent film, the light absorber absorbing visible rays having a wavelength other than wavelengths of red, green and blue lights, and (c) a transparent substrate to which the transparent film is adhered, the transparent substrate being positioned in alignment with the screen.

For instance, the function is accomplished by (a) a transparent film having an adhesive layer on one of upper and lower surfaces, (b) a light absorber mixed in the adhesive layer, the light absorber absorbing visible rays having a wavelength other than wavelengths of red, green and blue lights, and (c) a transparent substrate to which the transparent film is adhered through the adhesive layer, the transparent substrate being positioned in alignment with the screen.

For instance, the function is accomplished by (a) a transparent film, and (b) a light absorber mixed in the transparent film, the light absorber absorbing visible rays having a wavelength other than wavelengths of red, green and blue lights, the transparent film being adhered to the screen.

For instance, the function is accomplished by (a) a transparent film having an adhesive layer on one of upper and lower surfaces, and (b) a light absorber mixed in the adhesive layer, the light absorber absorbing visible rays having a wavelength other than wavelengths of red, green and blue lights, the transparent film being adhered to the screen through the adhesive layer.

For instance, the light absorber may be comprised of pigment.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a cross-sectional view of a conventional display filter arranged in alignment with a screen of a display unit.

FIG. 2 is a cross-sectional view of a display filter arranged in alignment with a screen of a display unit, in accordance with the first embodiment of the present invention.

FIG. 3A is a cross-sectional view of a display filter arranged in alignment with a screen of a display unit, in accordance with the second embodiment of the present invention.

FIG. 3B is a cross-sectional view of a display filter arranged in alignment with a screen of a display unit, in accordance with the third embodiment of the present invention.

FIG. 3C is a cross-sectional view of a display filter arranged in alignment with a screen of a display unit, in accordance with the fourth embodiment of the present invention.

FIG. 3D is a cross-sectional view of a display filter arranged in alignment with a screen of a display unit, in accordance with the fifth embodiment of the present invention.

FIG. 4 is a cross-sectional view of a display filter arranged in alignment with a screen of a display unit, in accordance with the sixth embodiment of the present invention.

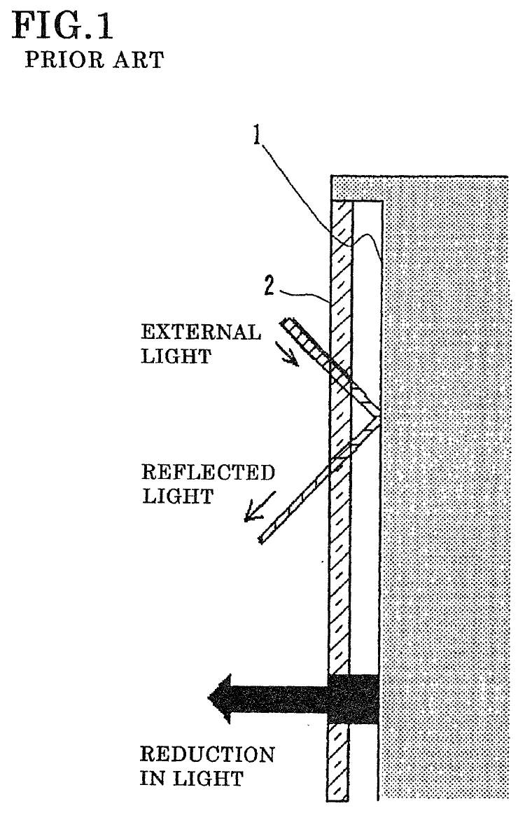

### DESCRIPTION OF THE PREFERRED EMBODIMENTS

Preferred embodiments in accordance with the present invention will be explained hereinbelow with reference to drawings.

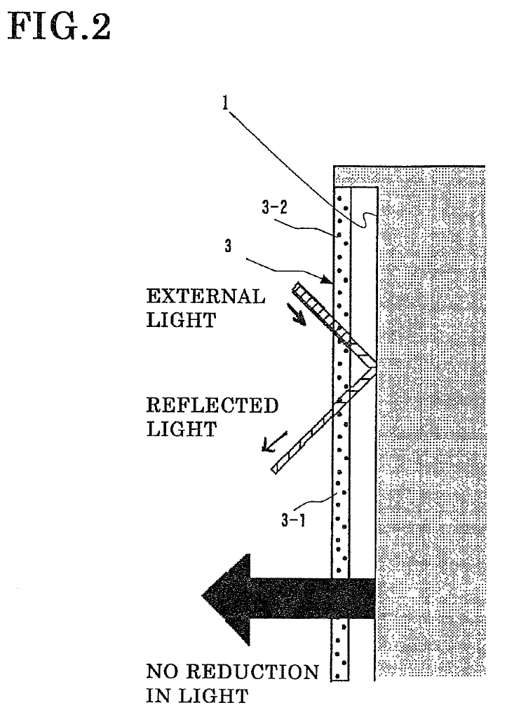

FIG. 2 is a cross-sectional view of a display filter in accordance with the first embodiment.

The display filter 3 is arranged in alignment with a screen of a display unit 1, and is designed to have a function of absorbing visible rays having a wavelength other than wavelengths of red, green and blue lights.

Specifically, the display filter 3 is comprised of a transparent substrate 3-1 positioned in alignment with a screen of the display unit 1, and light absorbers 3-2 mixed in the transparent substrate 3-1. The light absorbers 3-2 absorb visible rays having a wavelength other than wavelengths of red, green and blue lights.

It should be noted that it is difficult for the light absorbers 3-2 to entirely absorb visible rays having a wavelength other than wavelengths of red, green and blue lights, and hence a part of visible rays is not absorbed in the light absorbers 3-2, and resultingly, passes through the transparent substrate 3-1. Hence, in the specification, the phrase “absorb visible rays having a wavelength other than wavelengths of red, green and blue lights” means to absorb all or most of visible rays having a wavelength other than wavelengths of red, green and blue lights.

For instance, the display unit 1 may be comprised of a liquid crystal display device.

For instance, the transparent substrate 3-1 is composed of glass or resin such as methyl polymethacrylate (PMMA) or polycarbonate (PC). The light absorbers 3-2 are mixed directly into the transparent substrate 3-1.

The light absorbers 3-2 are composed of pigment which absorbs visible rays having a wavelength other than wavelengths of red, green and blue lights.

With reference to FIG. 2, visible rays having a wavelength other than wavelengths of red, green and blue lights, in external lights directing to the display unit 1, are absorbed into the display filter 3. Thus, external lights reaching the display unit 1 are reduced. The external lights having reached the display unit 1 through the display filter 3 are reflected at a screen of the display unit 1, and directed outwardly through the display filter 3.

The display unit 1 emits lights through the display filter 3. The display filter 3 absorbs visible rays having a wavelength other than wavelengths of red, green and blue lights. In other words, the display filter 3 allows red, green and blue lights to pass therethrough. Hence, red, green and blue lights emitted from the display unit 1 are not reduced.

As explained above, since the display filter 3 absorbs visible rays having a wavelength other than wavelengths of red, green and blue lights, and allows red, green and blue lights to pass therethrough, lights emitted from the display unit 1 are not reduced, but only external lights reaching the display unit 1 and reflected at the display unit 1 are reduced. As a result, it is possible to significantly enhance contrast of the display unit 1. This ensures images clearly displayed on a screen of the display unit 1, and further ensures a viewer to be able to see images on a screen of the display unit in a bright place where sunlight directly enters the display unit 1 or reflected sunlight enters the display unit 1 as external lights.

In addition, even if a screen of the display unit 1 is not black in color, black images displayed on a screen is emphasized, since colors other than red, green and blue are all absorbed in the display filter 3.

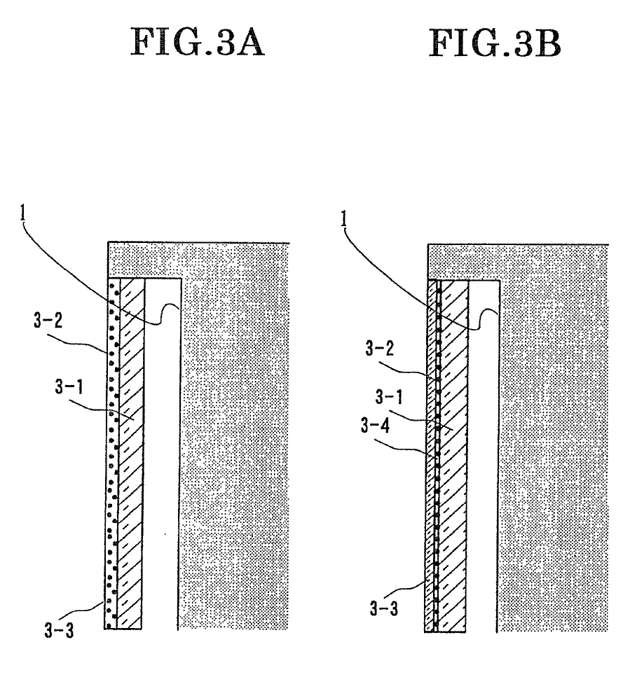

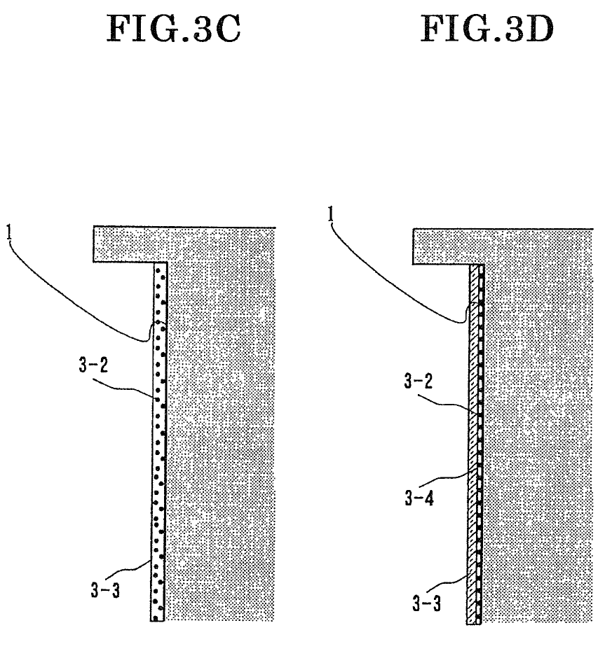

FIG. 3A is a cross-sectional view of a display filter in accordance with the second embodiment.

The display filter 3 is arranged in alignment with a screen of a display unit 1, and is designed to have a function of absorbing visible rays having a wavelength other than wavelengths of red, green and blue lights.

Specifically, the display filter 3 is comprised of a transparent film 3-3, light absorbers 3-2 mixed in the transparent film 3-3, and a transparent substrate 3-1 which is positioned in alignment with the screen and to which the transparent film 3-3 is adhered.

For instance, the display unit 1 may be comprised of a liquid crystal display device.

The light absorbers 3-2 are composed of pigment which absorbs visible rays having a wavelength other than wavelengths of red, green and blue lights.

For instance, the transparent film 3-3 is composed of polyethylene terephthalate (PET) or cellulose triacetate (TAC).

The display filter in accordance with the second embodiment presents the same advantages as those presented by the display filter in accordance with the first embodiment.

FIG. 3B is a cross-sectional view of a display filter in accordance with the third embodiment.

The display filter 3 is arranged in alignment with a screen of a display unit 1, and is designed to have a function of absorbing visible rays having a wavelength other than wavelengths of red, green and blue lights.

Specifically, the display filter 3 is comprised of a transparent film 3-3 having an adhesive layer 3-4 on a lower surface, light absorbers 3-2 mixed in the adhesive layer 3-4, and a transparent substrate 3-1 which is positioned in alignment with the screen and to which the transparent film 3-3 is adhered through the adhesive layer 3-4.

For instance, the display unit 1 may be comprised of a liquid crystal display device.

The light absorbers 3-2 are composed of pigment which absorbs visible rays having a wavelength other than wavelengths of red, green and blue lights.

For instance, the transparent film 3-3 is composed of PET or TAC.

The display filter in accordance with the third embodiment presents the same advantages as those presented by the display filter in accordance with the first embodiment.

FIG. 3C is a cross-sectional view of a display filter in accordance with the fourth embodiment.

The display filter 3 is arranged in alignment with a screen of a display unit 1, and is designed to have a function of absorbing visible rays having a wavelength other than wavelengths of red, green and blue lights.

Specifically, the display filter 3 is comprised of a transparent film 3-3 adhered directly to the screen, and light absorbers 3-2 mixed in the transparent film 3-3.

For instance, the display unit 1 may be comprised of a liquid crystal display device.

The light absorbers 3-2 are composed of pigment which absorbs visible rays having a wavelength other than wavelengths of red, green and blue lights.

For instance, the transparent film 3-3 is composed of PET or TAC.

The display filter in accordance with the fourth embodiment presents the same advantages as those presented by the display filter in accordance with the first embodiment.

FIG. 3D is a cross-sectional view of a display filter in accordance with the fifth embodiment.

The display filter 3 is arranged in alignment with a screen of a display unit 1, and is designed to have a function of absorbing visible rays having a wavelength other than wavelengths of red, green and blue lights.

Specifically, the display filter 3 is comprised of a transparent film 3-3 having an adhesive layer 3-4 on a lower surface, and light absorbers 3-2 mixed in the adhesive layer 3-4. The transparent film 3-3 is adhered directly to the screen through the adhesive layer 3-4.

For instance, the display unit 1 may be comprised of a liquid crystal display device.

The light absorbers 3-2 are composed of pigment which absorbs visible rays having a wavelength other than wavelengths of red, green and blue lights.

For instance, the transparent film 3-3 is composed of PET or TAC.

The display filter in accordance with the fifth embodiment presents the same advantages as those presented by the display filter in accordance with the first embodiment.

FIG. 6 is a cross-sectional view of a display filter in accordance with the sixth embodiment.

The display filter 4 is arranged in alignment with a screen of a display unit 1, and is designed to have a function of absorbing only external light in an area where the display unit 1 is located.

Specifically, the display filter 4 is comprised of a transparent substrate 4-1 positioned in alignment with a screen of the display unit 1, and light absorbers 4-2 mixed in the transparent substrate 4-1. The light absorbers 4-2 absorb visible rays having a wavelength other than wavelengths of red, green and blue lights.

For instance, the display unit 1 may be comprised of a liquid crystal display device.

For instance, the transparent substrate 4-1 is composed of glass or resin such as PMMA or PC.

The light absorbers 4-2 are composed of pigment which absorbs visible rays having a wavelength other than wavelengths of red, green and blue lights.

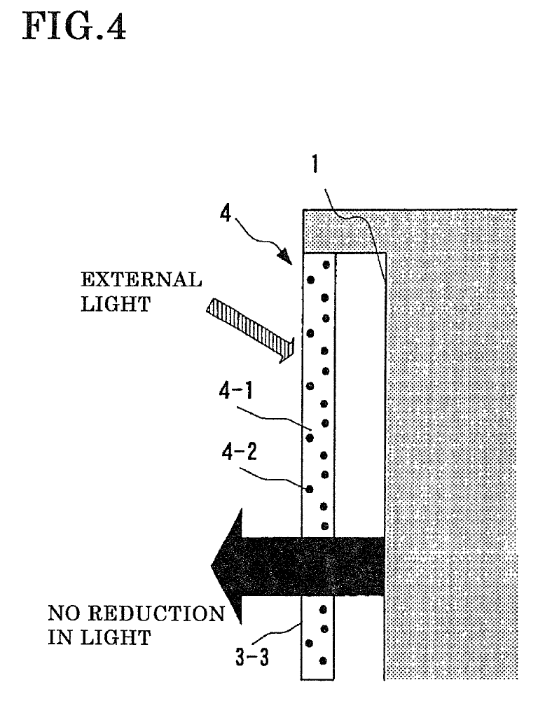

With reference to FIG. 4, visible rays having a wavelength other than wavelengths of red, green and blue lights, in external lights directing to the display unit 1, are absorbed into the display filter 4. Thus, external lights reaching the display unit 1 are reduced. The external lights having reached the display unit 1 through the display filter 4 are reflected at a screen of the display unit 1, and directed outwardly through the display filter 4.

The display unit 1 emits lights through the display filter 4. The display filter 4 absorbs visible rays having a wavelength other than wavelengths of red, green and blue lights. In other words, the display filter 4 allows red, green and blue lights to pass therethrough. Hence, red, green and blue lights emitted from the display unit 1 are not reduced.

As explained above, since the display filter 4 absorbs visible rays having a wavelength other than wavelengths of red, green and blue lights, and allows red, green and blue lights to pass therethrough, lights emitted from the display unit 1 are not reduced, but only external lights reaching the display unit 1 and reflected at the display unit 1 are reduced. As a result, it is possible to significantly enhance contrast of the display unit 1. This ensures images clearly displayed on a screen of the display unit 1, and further ensures a viewer to be able to see images on a screen of the display unit in a bright place where sunlight directly enters the display unit 1 or reflected sunlight enters the display unit 1 as external lights.

In addition, even if a screen of the display unit 1 is not black in color, black images displayed on a screen is emphasized, since colors other than red, green and blue are all absorbed in the display filter 4.

The display filter 4 in the sixth embodiment is designed to have the same structure as the structure of the filter display 3 in the first embodiment, however, it should be noted that the display filter 4 may be designed to have the same structure as the structure of the filter display 3 in the second, third, fourth or fifth embodiment.

Japanese Unexamined Patent Publication No. 9-113888 has suggested a liquid crystal display device including a film arranged in front of a display screen and having a function of absorbing a light having a predetermined wavelength. However, the film is designed to reduce reflectivity at an internal boundary in an upper glass substrate, and transmissivity of the upper glass substrate, and not designed to have a function of absorbing visible rays having a wavelength other than wavelengths of red, green and blue lights, and a function of absorbing only external light in an area where said display unit is used

Japanese Unexamined Patent Publication No. 9-145918 has suggested a filter having small raised- and recessed-portions at an upper surface for dispersing reflection of external lights, or having an anti-reflection (AR) coating layer for refracting lights having entered the filter, many times in the filter to thereby disallow the lights to leave the filter. Thus, it is possible to prevent contrast of images from lowering.

Japanese Unexamined Patent Publication No. 9-247584 has suggested an optical filter to be arranged in alignment with a plasma display panel (PDP). The optical filter has a light-permeable and electrically conductive mesh layer, an anti-reflection film adhered to the mesh layer for preventing scattering and reflection of lights, and a transparent layer formed on the film for preventing the anti-reflection film and mesh layer from being electrically charged. The optical filter is arranged in front of PDP such that the transparent layer faces PDP.

Japanese Unexamined Patent Publication No. 9-306366 has suggested an optical filter to be arranged in alignment with a plasma display panel (PDP). The optical filter is designed to have a layer for interrupting near infrared rays emitted from PDP, and further interrupting electromagnetic waves leaked out of PDP. For instance, the layer may be fabricated by forming a thin transparent layer composed of silver and inorganic oxide, onto a transparent film by sputtering.

In these Publications Nos. 9-145918, 9-247584 and 9-306366, pigment is mixed into a substrate for absorbing thereinto a red light emitted from PDP, to thereby prevent blue images from being purplish. However, the filters suggested in these Publications are not designed to have a function of absorbing visible rays having a wavelength other than wavelengths of red, green and blue lights, and a function of absorbing only external light in an area where said display unit is used.

Japanese Unexamined Patent Publication No. 11-143371 has suggested a filter adhered to a display panel through an adhesive layer. The adhesive layer is composed of epoxy, rubber or acrylic adhesive, an ultra-violet ray cross-linking accelerator, and a pigment. By controlling an amount of the pigment mixed into the adhesive layer, transmissivity of the filter to pass visible rays therethrough is adjusted to a desired transmissivity. However, the suggested filter is not designed to have a function of absorbing visible rays having a wavelength other than wavelengths of red, green and blue lights, and a function of absorbing only external light in an area where said display unit is used.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2001-8300 filed on Jan. 16, 2001 including specification, claims, drawings and summary is incorporated herein by reference in its entirety.

What is claimed is:

1. A display filter arranged in alignment with a screen of a display unit, said display filter having a function of absorbing visible rays having a wavelength other than wavelengths of red, green and blue lights.

2. The display filter as set forth in claim 1, wherein said function is accomplished by:
(a) a transparent substrate positioned in alignment with said screen; and
(b) a light absorber mixed in said transparent substrate, said light absorber absorbing visible rays having a wavelength other than wavelengths of red, green and blue lights.

3. The display filter as set forth in claim 1, wherein said function is accomplished by:
(a) a transparent film;
(b) a light absorber mixed in said transparent film, said light absorber absorbing visible rays having a wavelength other than wavelengths of red, green and blue lights; and
(c) a transparent substrate to which said transparent film is adhered, said transparent substrate being positioned in alignment with said screen.

4. The display filter as set forth in claim 1, wherein said function is accomplished by:
(a) a transparent film having an adhesive layer on one of upper and lower surfaces;
(b) a light absorber mixed in said adhesive layer, said light absorber absorbing visible rays having a wavelength other than wavelengths of red, green and blue lights; and
(c) a transparent substrate to which said transparent film is adhered through said adhesive layer, said transparent substrate being positioned in alignment with said screen.

5. The display filter as set forth in claim 1, wherein said function is accomplished by:
(a) a transparent film; and
(b) a light absorber mixed in said transparent film, said light absorber absorbing visible rays having a wavelength other than wavelengths of red, green and blue lights,
said transparent film being adhered to said screen.

6. The display filter as set forth in claim 1, wherein said function is accomplished by:
(a) a transparent film having an adhesive layer on one of upper and lower surfaces; and
(b) a light absorber mixed in said adhesive layer, said light absorber absorbing visible rays having a wavelength other than wavelengths of red, green and blue lights,
said transparent film being adhered to said screen through said adhesive layer.

7. The display filter as set forth in claim 2, wherein said light absorber is comprised of pigment.

8. A display filter arranged in alignment with a screen of a display unit, said display filter having a function of absorbing only external light in an area where said display unit is used.

9. The display filter as set forth in claim 8, wherein said function is accomplished by:
(a) a transparent substrate positioned in alignment with said screen; and
(b) a light absorber mixed in said transparent substrate, said light absorber absorbing visible rays having a wavelength other than wavelengths of red, green and blue lights.

10. The display filter as set forth in claim 8, wherein said function is accomplished by:
(a) a transparent film;
(b) a light absorber mixed in said transparent film, said light absorber absorbing visible rays having a wavelength other than wavelengths of red, green and blue lights; and
(c) a transparent substrate to which said transparent film is adhered, said transparent substrate being positioned in alignment with said screen.

11. The display filter as set forth in claim 8, wherein said function is accomplished by:
(a) a transparent film having an adhesive layer on one of upper and lower surfaces;
(b) a light absorber mixed in said adhesive layer, said light absorber absorbing visible rays having a wavelength other than wavelengths of red, green and blue lights; and
(c) a transparent substrate to which said transparent film is adhered through said adhesive layer, said transparent substrate being positioned in alignment with said screen.

12. The display filter as set forth in claim 8, wherein said function is accomplished by:
(a) a transparent film; and
(b) a light absorber mixed in said transparent film, said light absorber absorbing visible rays having a wavelength other than wavelengths of red, green and blue lights,
said transparent film being adhered to said screen.

13. The display filter as set forth in claim 8, wherein said function is accomplished by:
(a) a transparent film having an adhesive layer on one of upper and lower surfaces; and
(b) a light absorber mixed in said adhesive layer, said light absorber absorbing visible rays having a wavelength other than wavelengths of red, green and blue lights,
said transparent film being adhered to said screen through said adhesive layer.

14. The display filter as set forth in claim 9, wherein said light absorber is comprised of pigment.

15. A liquid crystal display device comprising:
(a) a liquid crystal display unit emitting lights externally; and
(b) a display filter arranged in alignment with a screen of said liquid crystal display unit, said display filter having a function of absorbing visible rays having a wavelength other than wavelengths of red, green and blue lights.

16. The liquid crystal display device as set forth in claim 15, wherein said function is accomplished by:
(b1) a transparent substrate positioned in alignment with said screen; and
(b2) a light absorber mixed in said transparent substrate, said light absorber absorbing visible rays having a wavelength other than wavelengths of red, green and blue lights.

17. The liquid crystal display device as set forth in claim 15, wherein said function is accomplished by:
(b1) a transparent film;
(b2) a light absorber mixed in said transparent film, said light absorber absorbing visible rays having a wavelength other than wavelengths of red, green and blue lights; and
(b3) a transparent substrate to which said transparent film is adhered, said transparent substrate being positioned in alignment with said screen.

18. The liquid crystal display device as set forth in claim 15, wherein said function is accomplished by:
(b1) a transparent film having an adhesive layer on one of upper and lower surfaces;
(b2) a light absorber mixed in said adhesive layer, said light absorber absorbing visible rays having a wavelength other than wavelengths of red, green and blue lights; and
(b3) a transparent substrate to which said transparent film is adhered through said adhesive layer, said transparent substrate being positioned in alignment with said screen.

19. The liquid crystal display device as set forth in claim 15, wherein said function is accomplished by:
(b1) a transparent film; and
(b2) a light absorber mixed in said transparent film, said light absorber absorbing visible rays having a wavelength other than wavelengths of red, green and blue lights,
said transparent film being adhered to said screen.

20. The liquid crystal display device as set forth in claim 15, wherein said function is accomplished by:
(b1) a transparent film having an adhesive layer on one of upper and lower surfaces; and
(b2) a light absorber mixed in said adhesive layer, said light absorber absorbing visible rays having a wavelength other than wavelengths of red, green and blue lights,
said transparent film being adhered to said screen through said adhesive layer.
